(19) United States
(12) Patent Application Publication
(10) Pub. No.: US 2022/0378639 A1
(43) Pub. Date: Dec. 1, 2022

(54) Sterile Accessory Mount

(71) Applicant: Mark Landon Sowers, Myrtle Beach, SC (US)

(72) Inventors: Mark Landon Sowers, Myrtle Beach, SC (US); Erin Leslie Ivey, Myrtle Beach, SC (US)

(73) Assignee: Mark Landon Sowers, Myrtle Beach, SC (US)

(21) Appl. No.: 17/742,020

(22) Filed: May 11, 2022

Related U.S. Application Data
(60) Provisional application No. 63/194,202, filed on May 28, 2021.

(51) Int. Cl. A61G 13/10

(52) U.S. Cl. CPC A61G 13/101

(57) ABSTRACT

A device used to mount items to a sterile table. The device having a base unit, an actuating unit, and at least one arm with a rounded tip. The base unit rests on a sterile table (or on or around a rigid item on a sterile table). The actuating unit is slidably coupled to the base unit, and the base unit and actuating unit extend below the top-surface-plane of the table. At least one arm is pivotally connected to the base unit in such a way that when the base unit is properly placed, the arm(s) extends under the table surface, below the vertical edge of the table. When force is applied to the actuating unit causing it to move, its movement then causes the arm(s) to engage with part of the table, holding the device in place.

### FIELD OF THE INVENTION

In general, the present invention relates to mounting systems for mounting objects onto the edge of a horizontal surface. More particularly, the present invention relates to mounting systems for mounting accessory items to a sterile operating room table.

### BACKGROUND OF THE INVENTION

Many operating rooms contain at least one piece of furniture upon which sterile items are organized and made ready to be used during a surgical procedure. From here on out I will refer to such a piece of furniture as a ‘back table’, but it should be understood that this method and device could be used on other sterile operating room tables, such as ‘prep tables’. The tops of these tables are often made from a sheet of stainless steel (usually 1 mm to 3 mm thick) laid horizontally, and supported by vertical legs, usually attached near the corners of the table top. These legs often sit on casters (wheels) that allow the table to be easily moved around the operating room. To provide additional support to the horizontal sheet of stainless steel, the edges of the sheet are often folded in such a way as to create a downward lip. This lip, often made from the same sheet of stainless steel at the table top, but folded 90 degrees downward, usually extend in the downward direction a distance of 2 cm to 6 cm, around and along the entire perimeter of the table top.

Before placing sterile items on a back table, the table surface itself must be made sterile. Most commonly this involves placing a sterile table cover or ‘drape’ across the top surface of the table, such that the drape hangs down over the edges of the table. Principles of aseptic technique dictate that only the top surface of a draped sterile table should be considered sterile. Any part of the drape (or any part of any other item or person) that falls below the top-surface-plane of the table should be considered un-sterile, and therefore a sterile member of the surgical team should not allow any item (or part of an item) meant to remain sterile to pass below the top-surface-plane of the table, also known as ‘the level of the sterile field’. This includes the sterile gloves worn by sterile members of the surgical team.

After the table has been prepared, should a sterile member of the surgical team desire to move the table to a different location in the operating room, the inability to touch the sides of the table makes this maneuver challenging. The common technique employed by sterile members of the surgical team involves said member placing their gloved hands flat on the table top and pressing downward in hopes of creating enough friction between the smooth table surface and the sterile drape, so that when lateral force is then applied by the hands, the table itself rolls laterally, and the drape does not slide along the surface of the table. This is often a challenging maneuver, and occasionally the drape will slide, causing un-sterile portions of the drape to move up onto the top surface of the table, or even causing sterile items placed on the drape to fall off the edge of the table (both of which are undesirable results).

Also given the limited space on a sterile back table, it would be helpful to have a device which supports sterile items some distance above the surface of the table, without contaminating those items. While a simple support device could be sterilized and set on the table top (and the drape), such a device might tip over if it is not securely attached to the table in some way.

The ability to securely attach a sterile device to a sterile back table would solve both of these problems. If the attached device included a handle that remains above the top-surface-plane of the table, a sterile member of the surgical team could grab said handle with their sterile glove and apply lateral force to the table, causing it to move, while not risking having the drape slide out of place. If the attached device could securely hold a support, which can then hold sterile items some distance above the surface of the table, this more efficient use of space would allow a sterile member of the surgical team to more easily view and retrieve needed sterile items.

### PRIOR ART

Many previous art devices that allow an item to be attached to a table involve some type of clamp (usually a variation on the c-clamp or spring clamp) that can be used to engage the edge of the table. Such prior art clamps have one or more of the following issues that would make them unsuitable for the use described above: 1) they would require the sterile member of the surgical team to place their hands in a position below the top-surface-plane of the table, 2) they would not effectively engage a table made of a thin sheet with a vertical edge, 3) they would be comprised of relatively-sharp corners or edges that, during the process of engaging the table, could puncture or tear the drape, 4) during the process of engaging with the table, some part of the clamp that was positioned below the top-surface-plane of the table would move to a position above the top-surface-plane of the table, and/or 5) they cannot be easily and quickly engaged by someone wearing thin sterile gloves without potentially causing damage to said gloves.

A need therefore exists for an improved device that can easily attach to a draped back table in such a way that it does not cause the hand of a sterile member of the surgical team to pass below the top-surface-plane of the table, while also protecting the integrity of both the drape and the sterile gloves.

### SUMMARY OF THE INVENTION

The present invention, a device used to mount accessory items to a sterile table, addresses the above-described deficiencies as well as other deficiencies associated with the prior art. In an aspect of the present invention, a mount, having a base unit, an actuating unit, and at least one arm with a rounded tip, uniquely designed to attach to a table of a style that is commonly found in surgical operating rooms, is presented.

### BRIEF DESCRIPTION OF DRAWINGS

These as well as other features of the present invention will become more apparent in the accompanying drawings wherein:

FIG. 1 is an upper perspective view of an embodiment in the closed position removably engaging an operating room table,

FIG. 2 is a lower perspective view of an embodiment in the closed position removably engaging an operating room table,

FIG. 3 is a lower perspective view of an embodiment in the open position,

FIG. 4 is a lower perspective view of an embodiment in the closed position,

FIG. 5 is front plane view of an embodiment in the open position,

FIG. 6 is front plane view of an embodiment in the closed position,

FIG. 7 is a lower perspective view of an embodiment with its primary component parts separated,

FIG. 8 is a top plane view of an embodiment in the open position,

FIG. 9 is an upper perspective view of a suture bag support accessory item,

FIG. 10 is an upper perspective view of a light accessory item.

### DETAILED DESCRIPTION OF DRAWINGS

The drawings referred to herein are for the purposes of illustrating one particular embodiment of the present invention, and are not meant to limit the scope of the present invention.

Within these figures similar reference characters denote similar elements throughout the several views. For the sake of clarity, a sterile drape which would commonly cover the operating room table is not shown.

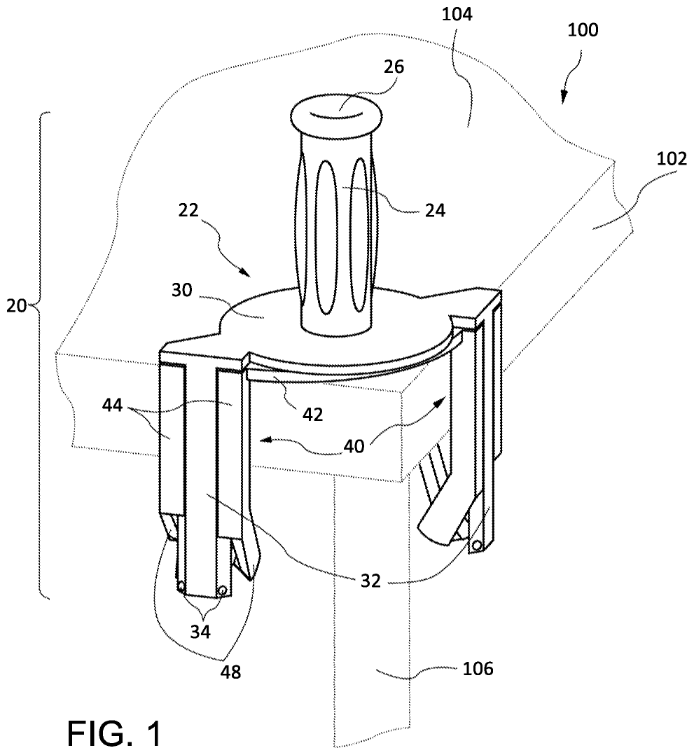

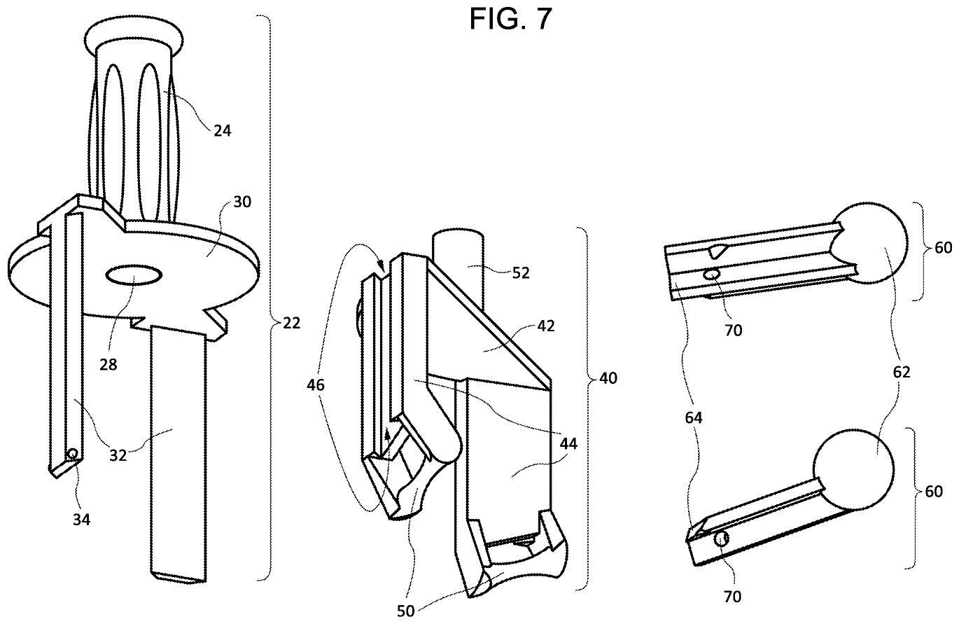

FIGS. 1 through 8 illustrate an embodiment of a sterile accessory mount (herein referred to as the mount) 20 which is comprised of an actuating unit 22, a base unit 40, and a plurality of arms 60, uniquely designed to attach to a table 100 of a style that is commonly found in surgical operating rooms. The individual units of the mount are best shown separately in FIG. 7. Tables of the type referred to are described in more detail in the Background of the Invention section above.

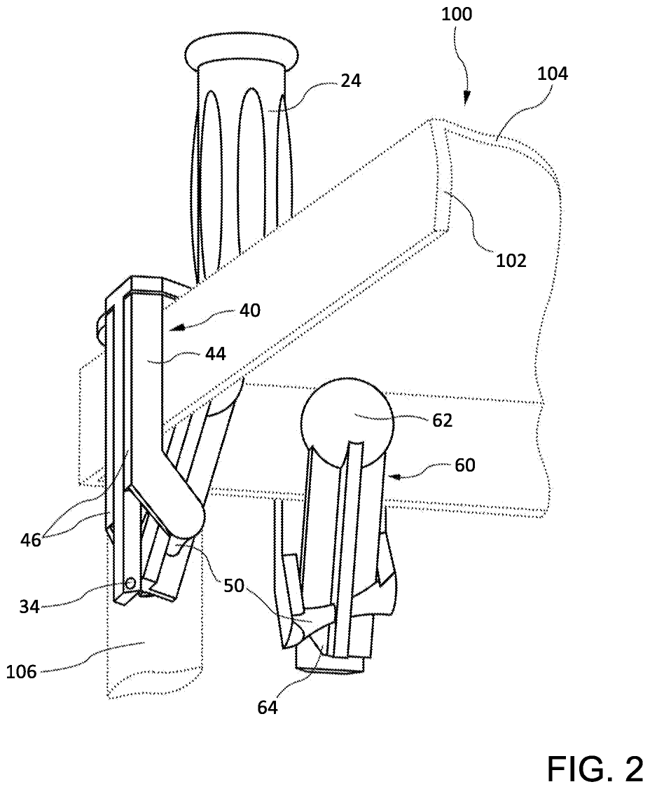

An operating room table 100 is best shown in FIGS. 1 and 2 having a vertical lip 102 extending downward from the perimeter of the table top 104. Legs 106 support the table 100 at the corners of the table top 104 and immediately behind the table lip 102.

As shown in FIGS. 1 and 2, this embodiment of the mount 20, in its closed position, is removably attached to the table 100.

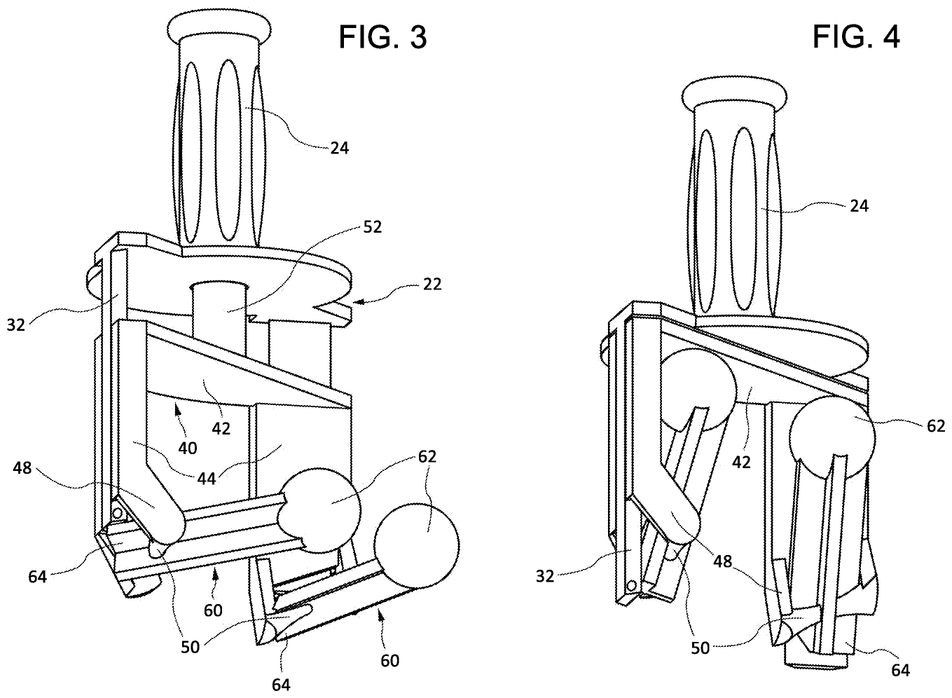

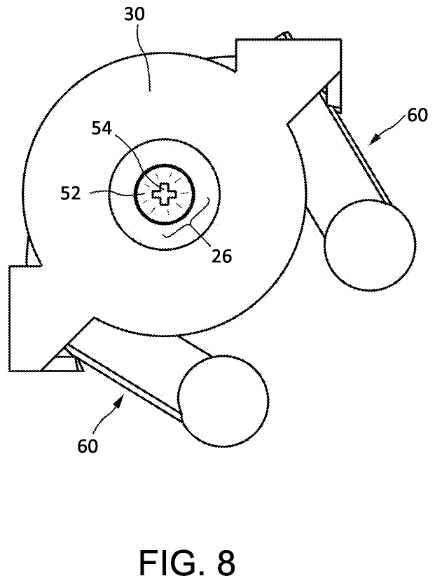

As best shown without the table in FIGS. 3 and 7 and with the table in FIGS. 1 and 2, the base unit 40 is comprised of a flat base element 42, one or more downward members 44, and one or more upward members 52. In this embodiment, the flat base 42 rests upon the top table surface 104. The downward members 44 extend past the vertical lip of the table 102. At the top end, each downward member 44 connects to the flat base 42. Each downward member 44 has a vertical channel 46 through which the corresponding downward member of the actuating unit 32 is slidably fitted. Attached to the bottom end of each downward member 44 is a hinge 50, around which an arm 60 pivots. The upward member 52 functions as a guide limiting the motion of the actuating unit 22 to the vertical direction. As best shown in FIG. 8, the upward member 52 is also comprised of a receptacle 54 that accepts a variety of accessory items.

As best shown in FIGS. 1 and 7, the actuating unit 22 includes an ergonomic handle 24 which is hollow and open at the top 26 and at the bottom 28. The bottom of this hollow opening 28 is sized so that it fits around the upward member 52 of the base unit 22. Extending horizontally from the bottom of the handle 24 is a disc 30 which acts as a shield to help prevent the gloved hand of a sterile member of the surgical team from accidently getting caught in the mount, or accidently passing below the top-surface-plane of the table. As best shown in FIG. 7, the actuating unit 22 includes one or more downward members 32, each of which are slidably fitted into a channel 46 in the corresponding downward member of the base unit 44.

The actuating unit 22 is slidably coupled to the base unit 40 in a fashion that allows it to move independent of the base unit, but only in a vertical direction. One or more knobs 34 are attached near the bottom of the downward members of the actuating unit 32. These knobs 34 make this section of the downward member 32 wider than the channel 46, preventing the actuating member 22 from pulling out of the channel 46.

As best shown in FIGS. 3 and 7 each arm 60 is comprised of a proximal end 64 and a distal end 62. The distal end of the arm 62 is rounded and smooth, so as not to snag or tear a sterile drape that may be hanging over the edge of the table. In the open position, the arm 60 extend in a generally horizontal direction under the lip 102 and surface 104 of the table 100 shown in FIG. 2. The proximal end of the arm 64 extends into the motion-path of the downward member of the actuating unit 32. Between the proximal and distal ends of the arm, and closer to the proximal end, the arm 60 is pivotally attached to the hinge of the base unit 50.

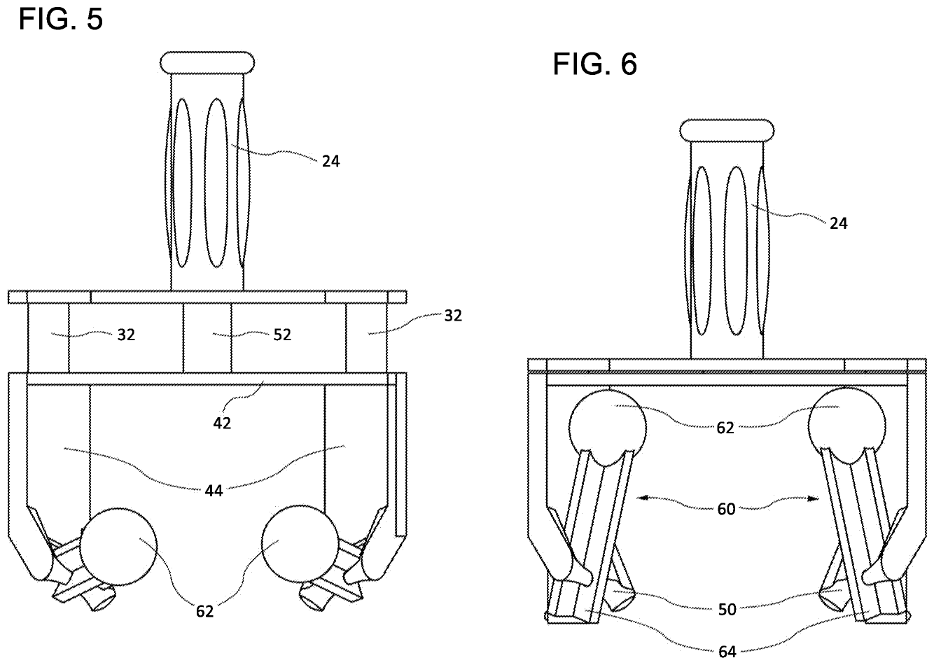

This hinge 50 is supported by hinge supports 48 and mounted at an angle of approximately 25 degrees askew from horizontal. The corresponding hole 70 through the arm 60 is angled approximately 65 degrees askew of the longitudinal axis of the arm 60. The angles of both the hinge 50 and the hole 70 work together in such a way that, while in the closed position the arms 60 align with the downward member of the base unit 44, and as best shown in FIGS. 5 and 8, when in the open position the distal ends 62 of the arms 60 separate from each other outward to an extent great enough to allow the leg of the table 106 to easily pass between them. The proximal end 64 of the arm is shaped in such a way as to permit this compound-angle opening without interference from the hinge supports 48.

Operation of the mount is best shown in FIGS. 2, 3 and 4. The mount would be pre-sterilized before being added to the sterile field. When this embodiment of the invention is in the open position, shown in FIG. 3, the actuating unit 22 is slidably coupled to the base unit 40, but sits several centimeters above the base unit. With the downward projections of the actuating unit 32 in this higher position, the arms 60 are free to lay in a generally horizontal position, with their distal ends 62 separated from each other. With the mount 20 in this position, the sterile member of the surgical team holds the mount by the ergonomic handle 24 and places it over the edge of the table 100 so that the flat base 42 rests on the table top 104, and the arms 60 extend under the lip of the table 102 and table top 104.

To convert this embodiment of the invention to the closed position, the sterile member of the surgical team takes hold of the handle 24 and presses downward, which moves the actuating unit in a downward direction towards the table surface 104. The downward members of the actuating unit 34 also move downward. As they do so, they push down on (and eventually past) the proximal ends of the arms 64. The hinge 50 acts as a fulcrum such that when the proximal ends of the arms 64 are pushed downward, the distal ends of the arms 62 move upwards, smoothly sliding along the drape, until the arms 60 are in an almost vertical orientation and the distal ends of the arms 62 engage with the back of the lip of the table 102, just under the table top 104.

At no point during its positioning or deployment does any part of the mount below the top-surface-plane of the table move to a position above the top-surface-plane of the table. Also at no point during the positioning or deployment of the mount does the gloved hand of the sterile member of the surgical team, move to a position below the top-surface-plane of the table. Both the sterile glove and the drape are protected from snags, cuts, and penetrations at all times.

In its closed position, the mount 20 is securely attached to the table 100. When lateral force is applied to the handle 24, said force is carried through the mount 20 to the lip of the table 102, allowing the table to move laterally, while maintaining in place any drape that may be covering the table. Any accessory item that is placed in the receptacle 54 would be held more securely in place than an equivalent item would be if it were set on the table top.

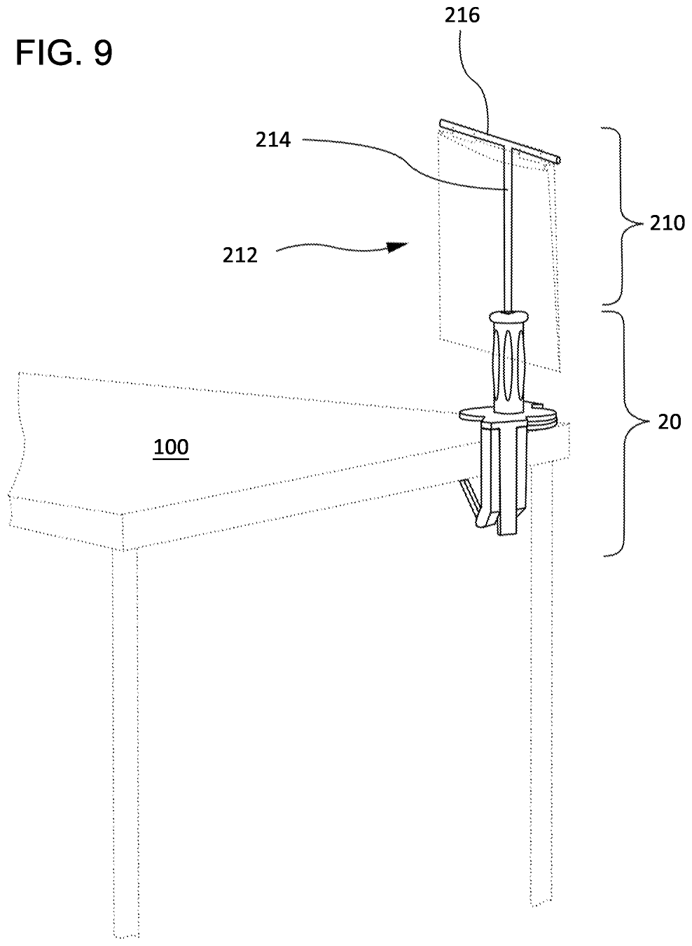

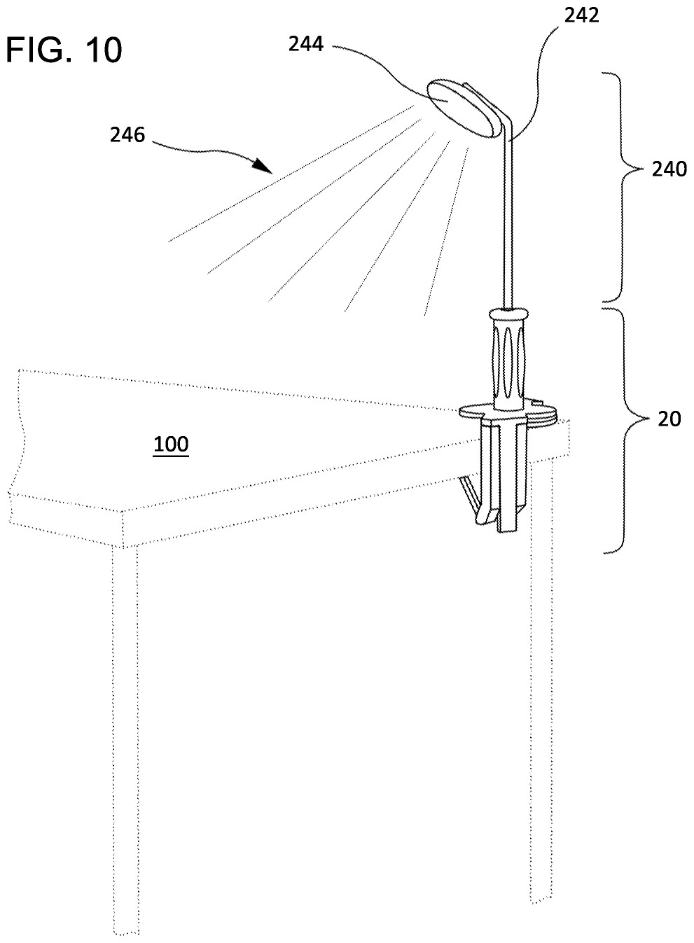

FIGS. 9 and 10 illustrate two examples of the many types of accessory items that could be held in place by the mount.

FIG. 9 illustrates a suture bag support accessory item 210, where a suture bag 212 is attached to a horizontal element 216 supported by a vertical element 214. This accessory item 210 is inserted into and held in place by the mount 20. An advantage of this accessory item is that it keeps the entirety of the suture bag above the top-surface-plane of the sterile table 100, which allows a sterile member of the surgical team to freely manipulate, remove, or tear open the suture bag 212.

FIG. 10 illustrates a light accessory item 240, where a self-powered light 244 is attached to a vertical element 242. This accessory item 240 is inserted into and held in place by the mount 20. An advantage of this accessory item is that the light can provide directed illumination 246 of the sterile table 100 during times when the overhead lights in the operating room are turned off, as often is the case during endoscopic and robotic procedures.

Numerous additional modifications and changes will be obvious to those skilled in the art. Therefore, the above descriptions and attached figures are not meant to limit the scope of the invention in any way.

I claim:

1. A mount assembly for an operating room table comprising:
(a) a base unit having at least one projection that extends over the side of said table;
(b) an actuating unit, having similar projection(s) as the base unit, joined to the base unit in such a way as to allow the actuating-unit projection(s) to slide in a vertical direction; and,
(c) at least one arm, pivotally attached to each base-unit projection.

2. The mount assembly of claim 1, wherein the base unit further includes a base which rests on the top surface of said table.

3. The mount assembly of claim 1, further including an ergonomic handle, that when pressed downward, causes the actuating-unit projection(s) to move in a downward direction.

4. The mount assembly of claim 3, further including a flat shield at the bottom of said handle.

5. The mount assembly of claim 1, wherein the arm(s) have a proximal end which extends into the motion-path of an actuating-unit projection.

6. The mount assembly of claim 1, wherein the arm(s) have a distal end which extends under the top surface of the table.

7. The mount assembly of claim 1, wherein the arm(s) have a distal end with a smooth and rounded tip.

8. The mount assembly of claim 1, wherein the arms pivot open at such an angle as to allow the distal ends of each arm to remain sufficiently far apart as to allow the leg of said table to easily pass between them.

9. The mount assembly of claim 1, wherein the arm(s) pivot closed in such a way that the distal end of each arm presses firmly against the table.

10. The mount assembly of claim 1, further including a receptacle that accepts accessory items.

11. The mount assembly of claim 1, further including an accessory item that supports the entirety of a suture bag above the top-surface-plane of the table.

12. The mount assembly of claim 1, further including an accessory item that supports a self-powered light.
